(19) United States
(12) Patent Application Publication
(10) Pub. No.: US 2011/0154776 A1
(43) Pub. Date: Jun. 30, 2011

(54) SIDING PANEL

(76) Inventor: Walter Brian SIMMS, Calhoun, GA (US)

(21) Appl. No.: 13/044,179

(22) Filed: Mar. 9, 2011

Related U.S. Application Data
(63) Continuation-in-part of application No. 12/454,159, filed on May 14, 2009.
(60) Provisional application No. 61/130,842, filed on Jun. 4, 2008.

(51) Int. Cl. E04G 21/14; B32B 3/00

(52) U.S. Cl. 52/748.11; 428/195.1

(57) ABSTRACT

An improved article of manufacturing for metal siding, which can be formed into or painted to have the texture and hand of raised grain which has the colors and appearance of weathered, rough sawn, or had hewn wood.

### CROSS-REFERENCE TO RELATED APPLICATIONS

This application is a continuation-in-part of U.S. Non-Provisional Patent Application Ser. No. 12/454,159, filed May 14, 2009, which claims the benefit of U.S. Provisional Patent Application Ser. No. 61/130,842, filed Jun. 4, 2008, the entireties of which are hereby incorporated herein by reference for all purposes.

### TECHNICAL FIELD

The present invention relates generally to construction materials, and more particularly to a vertical siding panel formed of metal or sheet material and presenting an external appearance of natural wood siding such as, for example, aged vertical board-and-batten siding construction.

### BACKGROUND

Conventional metal siding has a smooth finish with formed arching ribs placed in the longitudinal axis yielding strength and rigidity for the panels. This architectural design has been the most prominent on the market with little else to choose from.

While previously known forms of siding have been useful for their particular purpose, none have an appearance of old wood siding, which substantially limits the overall look of a building once completed. These conventional siding panels have been described as architectural siding panels and are only distinguished from each other by the difference in color and not for their varying textural appearances.

### SUMMARY

The present invention relates to construction materials, and more particularly to an article of manufacture for metal or other sheet panel siding construction. By having wood grain painted, stamped or formed in any other manner found to produce said wood grain affect, a metal siding can be produced according to example forms of the invention to give a building the appearance of an old wood siding structure.

Batten strips may be formed along the vertical axis in representative embodiments of the invention, following a predetermined pattern to further replicate vertical plank siding. These batten strips can be extended out from the surface or recessed as in a reverse board and batten type construction.

A painted, etched or screen printed wood grain pattern can be applied to example embodiments of the invention to result in the same appearance as a raised grain affect and can even have a stained finish look. A texture with a depth dimension is optionally created with the use of a wood grain affect and by forming batten strips at a combination of panel widths within the sheet the uniform pattern is replaced with a look that is similar to that of real wood siding.

In one aspect, the invention relates to a siding panel including a substantially planar non-wooden sheet having first and second sides defining a width therebetween, first and second ends defining a length therebetween, the length being greater than the width and extending in a direction perpendicular to the width. The panel preferably further includes an interior face and an exterior face, wherein at least a portion of the exterior face comprises a surface having the appearance of natural wood grain. The first and second sides preferably define a finished edge without connection elements thereon. The sheet is preferably formed to have raised and lowered sections defining a depth in a dimension normal to the width and the length.

In another aspect, the invention relates to a siding panel including a metal sheet having first and second sides defining a width therebetween, first and second ends defining a length therebetween, the length being greater than the width and extending in a direction perpendicular to the width. The panel preferably further includes an interior face and an exterior face, wherein at least a portion of the exterior face comprises a surface having the appearance of natural wood grain. The first and second sides preferably define a finished edge without connection elements thereon.

In yet another aspect, the invention relates to a siding panel including a metal sheet having first and second sides defining a width therebetween, first and second ends defining a length therebetween, the length being greater than the width and extending in a direction perpendicular to the width. The panel preferably further includes an interior face and an exterior face, wherein at least a portion of the exterior face comprises a surface having the appearance of natural wood grain. The first and second sides preferably define a finished edge without connection elements thereon. The metal sheet is preferably formed to have raised and lowered sections defining a depth in a dimension normal to the width and the length, the raised and lowered sections presenting the appearance of parallel wooden planks having batten strips between the parallel wooden planks and having varying spacing in the width-wise direction, presenting the appearance of planks of varying width. The exterior face is preferably textured and colored to provide the appearance of natural wood grain. The width of the panel preferably comprises a dimension about equal to a multiple of 16″.

In another aspect, the invention relates to a method of sheathing a building. The method preferably includes the step of providing a plurality of metal siding panels each having first and second sides defining a width therebetween, first and second ends defining a length therebetween, the length being greater than the width and extending in a direction perpendicular to the width, an interior face and an exterior face, wherein at least a portion of the exterior face comprises a surface having the appearance of natural wood grain, and wherein the first and second sides define a finished edge without connection elements thereon, and wherein the sheet is formed to have raised and lowered sections defining a depth in a dimension normal to the width and the length. The method preferably further includes the step of attaching the panels to a structure with confronting sides of adjacent panels abutting or overlapping, but not interlocking with one another, to form a vertical siding array.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows a stamped section of light gauge steel that shows the detail of the wood grain and knot characteristics similar to that of old weathered wood, as for example formed by pressure embossing the image onto the metal.

FIG. 2 shows a material having an image of wood grains and other characteristics of wood as for example may be applied to metal siding in a screen printing or other repetitive and high-speed technique, similar to a T-shirt screening process.

FIG. 3 shows a section of siding panel having raised or reversed strips of irregularly spaced batten and board pattern elements.

FIGS. 3a and 3b show an end view of siding panels having different types of batten strips formed into the metal surface as protruding or reversed.

FIG. 4 shows an edge view in cross-sectional profile of another embodiment of a siding panel having a backing material such as insulation applied thereon.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

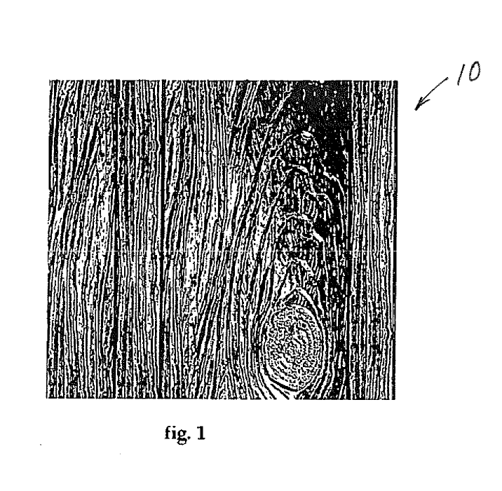

Turning to the drawings, the siding can be made by various different techniques used to create the appearance of real wood. FIG. 1 shows a detailed view of a section of a siding material 10 formed by a stamped technique in which castings were made from rubber polymers being poured onto a weathered wood surface and then once these molds cured a hard and durable plastic polymer resin was cast onto this mold to duplicate the features as a negative mold of the wood surface. A hydraulic press was then used to form a light gauge metal into an exact replica of the original wooden planks including the batten strip ribs.

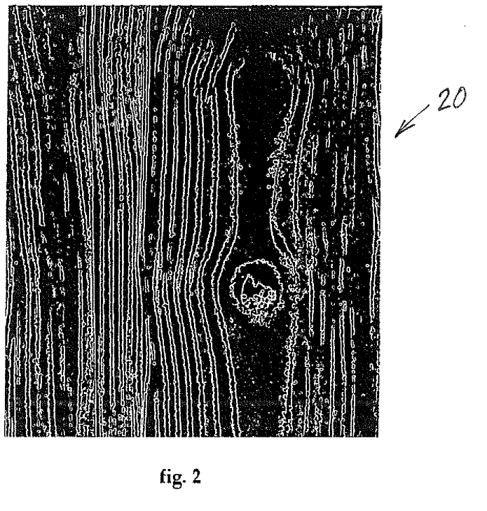

FIG. 2 shows a section of a siding material 20 comprising a piece of light gauge metal that was painted with a yellow exterior grade Latex house paint. Burgundy paint was then smeared on at random with a rag to create variations within the surface. A screen image made by a local T-shirt manufacturer duplicating the wood grain features was then screened onto the painted metal surface with a black flat finish exterior grade latex paint.

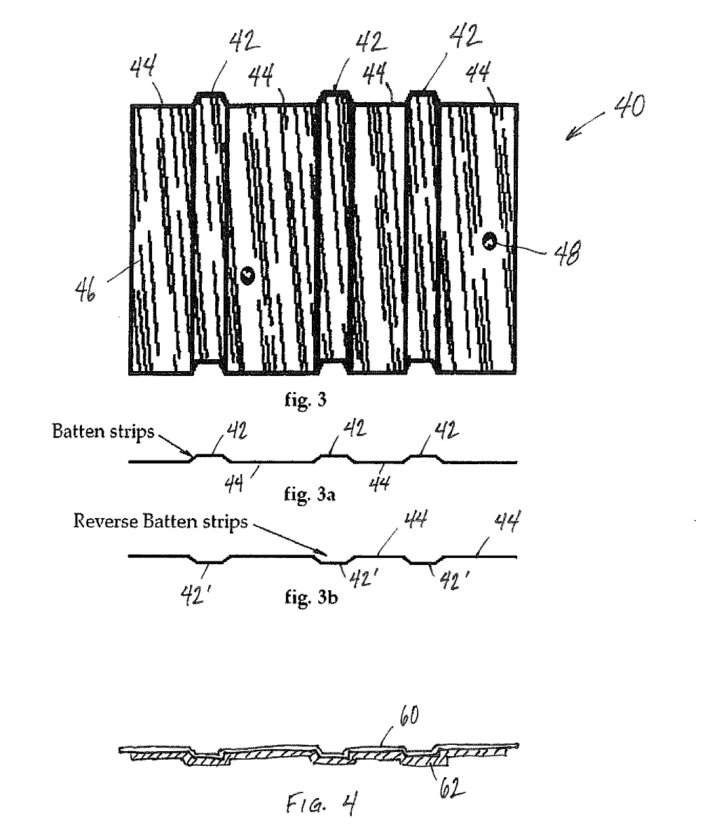

FIG. 3 shows a section of a siding panel 40 having raised and/or lowered batten strip features 42 and their random or uneven placement spaced between board features 44 to produce the appearance of batten-and-board siding construction having boards of varying panel widths. These batten strips create greater rigidity in the siding by placing them along the longitudinal axis, in which they act as stiffening reinforcement for the siding. The intermediate webs extending between the raised and lowered segments of the panel are shown as being oriented at about 45° angles relative to the planes of the front and back faces of the siding panel, but in alternate embodiments may be oriented at steeper or shallower angles of for example between 5°-90°. Optionally, the batten and/or board portions of the panel have a wood-grain pattern 46 and/or knot patterns 48 applied thereon or thereto, for example as described with reference to the embodiments of FIGS. 1 or 2.

Siding panels according to example forms of the invention can be fabricated from metal sheet or roll material such as rolled or extruded aluminum or steel. Alternatively, the panels may be fabricated from plastic or polymeric materials such as vinyl or polyethylene; from ceramic or cementitious materials; and/or from other materials of construction. The panels may be formed in lengths of, for example about 8′, 10′, 12′, 14′, 16′, 20′, or longer or shorter lengths. Alternatively, continuous length roll stock can be site-formed as by rolling into panels of virtually any desired length. Optionally, the panels are formed in widths of about 16″ or multiples thereof, such as for example 32″, 48″, 96″, or alternatively in other widths corresponding to standard spacing of studs or other structural building members. An additional overlap width of about ½″ to about 2″-4″, for example about 1½″ may be added to the nominal panel width to provide horizontal overlap of the sides of adjacent vertical panels; and a panel having such additional overlap width, and/or otherwise being within 10-15% (greater or lesser) of the nominal width, would still be considered to be “about” the nominal width as defined herein.

This new metal siding design, described as being used for the construction industry, can be made to resemble any wood surface desired by employing any means contrived to achieve a wood grain appearance for metal siding. By varying the widths of the “board” panel segments being used between the “batten” panel segments, a product can be created that further replicates the look of a real wood, board and batten siding. These panels can be distinguished by having batten strips that are raised (42 in FIG. 3a), recessed (42′ in FIG. 3b) or imprinted onto the surface of the materials. It is not required that these panels be of different widths for this invention, this is only stated as a further means of replicating old wood siding as it is.

Any color or combination of colors can be used to accommodate a desired look for this invention no matter what the process of manufacture may involve. The siding may comprise a raised or lowered wood grain, appearing as a rough sawn lumber or having a weathered wood appearance, with or without knots. The panel may be stamped or indented to have batten strip sections, inverted or protruding at predetermined varying intervals, which resemble that of a traditional wooden vertical plank siding. The pattern may be painted, screened, etched or overlaid onto the surface, or applied as a preprinted vinyl laminate. Optionally, trim pieces can be created by similar processes to further accent the metal siding, for example edge panels, corner posts, door and window moldings, or the like. Greater panel rigidity can be achieved by means of the grain design being stamped or raised into the panels of the siding.

Optionally, the top, bottom and side edges of a siding panel according to an example form of the present invention do not include any interlocking connection profiles or coupling elements such as securing tabs, but are instead flat planar sections of the panel. Optionally, a closure or sealing means such as an expanded foam strip, a sealant bead, a gasket strip, an adhesive or compressible material, or the like is provided along one or more of the top, bottom and side edges of the panel for weather-sealing, insulation and/or integrity of construction. Mounting holes are optionally pre-drilled along one or more of the top, bottom and side edges of the panel for receiving fasteners to attach the panels to the supporting structure, for example spaced at regular and even intervals such as 24″ or 48″.

FIG. 4 shows a further embodiment of a siding panel 60, viewed from the top or bottom edge, and shown in cross-sectional view. A thermally and/or acoustically insulating material 62 such as an expanded foam, polystyrene, or the like is applied onto the back or interior face of the siding panel, for example by adhesive, co-molding, spray application, or other fabrication methods.

In an example method of application, one or more siding panels substantially as described herein are applied to a structure. For example, a building may have horizontal furring strips or braces extending along the top, bottom and optionally one or more intermediate levels, between studs, posts or other structural members. A first siding panel is positioned vertically and secured to the furring strips or braces, or alternatively to other structural support members, using nails, screws, rivets, bolts, welding, adhesive or other fastener(s) or fastening means. A second siding member is then positioned adjacent the first siding panel, optionally having an edge portion overlapping or abutting a confronting edge portion of the first siding member, and similarly fastened in place. Alternatively, adjacent siding members may be installed parallel to one another and having a space therebetween in applications where ventilation is desired. In further optional embodiments, a batten panel or strip is attached over the seam between adjacent siding members. Successive siding members are installed in like manner about the periphery of the building to form an enclosure.

While the invention has been described with reference to preferred and example embodiments, it will be understood by those skilled in the art that a variety of modifications, additions and deletions are within the scope of the invention, as defined by the following claims.

What is claimed is:

1. A siding panel comprising a substantially planar non-wooden sheet having first and second sides defining a width therebetween, first and second ends defining a length therebetween, the length being greater than the width and extending in a direction perpendicular to the width, an interior face and an exterior face, wherein at least a portion of the exterior face comprises a surface having the appearance of natural wood grain, and wherein the first and second sides define a finished edge without connection elements thereon, and wherein the sheet is formed to have raised and lowered sections defining a depth in a dimension normal to the width and the length.

2. The siding panel of claim 1, wherein the raised and lowered sections present the appearance of parallel wooden planks.

3. The siding panel of claim 2, wherein the raised and lowered sections further present the appearance of batten strips between the parallel wooden planks.

4. The siding panel of claim 2, wherein the raised and lowered sections have varying spacing in the width-wise direction, presenting the appearance of planks of varying width.

5. The siding panel of claim 1, wherein the exterior face is textured to provide the appearance of natural wood grain.

6. The siding panel of claim 1, wherein the exterior face is colored to provide the appearance of natural wood grain.

7. The siding panel of claim 1, comprising a vertical siding panel adapted to be installed with the length vertical and the width horizontal.

8. The siding panel of claim 1, wherein the non-wooden sheet is metal.

9. The siding panel of claim 1, wherein the width comprises a dimension about equal to a multiple of 16″.

10. A siding panel comprising a metal sheet having first and second sides defining a width therebetween, first and second ends defining a length therebetween, the length being greater than the width and extending in a direction perpendicular to the width, an interior face and an exterior face, wherein at least a portion of the exterior face comprises a surface having the appearance of natural wood grain, and wherein the first and second sides define a finished edge without connection elements thereon.

11. The siding panel of claim 10, wherein the metal sheet is formed to have raised and lowered sections defining a depth in a dimension normal to the width and the length.

12. The siding panel of claim 11, wherein the raised and lowered sections present the appearance of parallel wooden planks.

13. The siding panel of claim 12, wherein the raised and lowered sections further present the appearance of batten strips between the parallel wooden planks.

14. The siding panel of claim 12, wherein the raised and lowered sections have varying spacing in the width-wise direction, presenting the appearance of planks of varying width.

15. The siding panel of claim 10, wherein the exterior face is textured to provide the appearance of natural wood grain.

16. The siding panel of claim 10, wherein the exterior face is colored to provide the appearance of natural wood grain.

17. The siding panel of claim 10, comprising a vertical siding panel adapted to be installed with the length vertical and the width horizontal.

18. The siding panel of claim 10, wherein the width comprises a dimension about equal to a multiple of 16″.

19. A siding panel comprising a metal sheet having first and second sides defining a width therebetween, first and second ends defining a length therebetween, the length being greater than the width and extending in a direction perpendicular to the width, an interior face and an exterior face, wherein at least a portion of the exterior face comprises a surface having the appearance of natural wood grain, and wherein the first and second sides define a finished edge without connection elements thereon, wherein the metal sheet is formed to have raised and lowered sections defining a depth in a dimension normal to the width and the length, the raised and lowered sections presenting the appearance of parallel wooden planks having batten strips between the parallel wooden planks and having varying spacing in the width-wise direction, presenting the appearance of planks of varying width, wherein the exterior face is textured and colored to provide the appearance of natural wood grain, and wherein the width comprises a dimension about equal to a multiple of 16″.

20. A plurality of the siding panels of claim 19 attached to a structure with confronting sides of adjacent panels abutting or overlapping, but not interlocking with one another, to form a vertical siding array.

21. A method of sheathing a building comprising providing a plurality of metal siding panels each having first and second sides defining a width therebetween, first and second ends defining a length therebetween, the length being greater than the width and extending in a direction perpendicular to the width, an interior face and an exterior face, wherein at least a portion of the exterior face comprises a surface having the appearance of natural wood grain, and wherein the first and second sides define a finished edge without connection elements thereon, and wherein the sheet is formed to have raised and lowered sections defining a depth in a dimension normal to the width and the length; and attaching the panels to a structure with confronting sides of adjacent panels abutting or overlapping, but not interlocking with one another, to form a vertical siding array.
